(19) United States
(12) Patent Application Publication
(10) Pub. No.: US 2006/0125780 A1
(43) Pub. Date: Jun. 15, 2006

(54) Method for representing a graphical object and communication device

(76) Inventor: Alexander Jarczyk, Freising (DE)

Correspondence Address: BELL, BOYD & LLOYD, LLC, P. O. BOX 1135, CHICAGO, IL, 60690-1135, US

(21) Appl. No.: 10/559,017

(22) PCT Filed: Dec. 9, 2003
(86) PCT No.: PCT/DE03/04050

§ 371 Date: Nov. 29, 2005

(30) Foreign Application Priority Data
May 28, 2003 (DE) 103 24 371.2

(51) Int. Cl. G09G 5/00

(52) U.S. Cl. 345/156

(57) ABSTRACT

The present disclosure relates to a method for representing a graphical object. The method is characterized in that a movement of an input device is converted to a graphical object, and the graphical object is represented on a display device and the representation of the graphical object is automatically displaced towards the center of the display device in response to the movement of the input device.

### FIELD OF TECHNOLOGY

The present disclosure relates to a method for representing a graphical object to a corresponding communication device, such as a mobile telephone or a computer.

### BACKGROUND

Advancing development in the field of mobile telephones has led to increasing miniaturization of said mobile telephones and to progressively improved graphics capabilities of mobile telephones. From this results a demand from the users of such mobile telephones to use the graphics capabilities of said mobile telephones efficiently in spite of the limited area available on the display device.

One means of inputting graphical objects into a communication device is by using an input pen or stylus which has a sensor device in the tip of the input pen. By means of this sensor device the movement of the input pen tip, and consequently the movement of the input pen relative to the surface over which the input pen is moved, is registered. The registered relative movement can then be translated into a corresponding graphical object that is finally represented on the display device. Thus, for example, the letter “a” can be written as a graphical object with the input pen tip in order to represent the letter “a” as a graphical object on the display device.

When such input pens are used, particularly in combination with communication devices having a small display, it proves a problem that the available area of the display device is not used efficiently by the graphical objects that are to be represented because the input of the graphical objects and the representation of the graphical objects with regard to scaling and reference point take place independently of each other.

### SUMMARY

Accordingly, an arrangement is disclosed that enables graphical objects that are input by means of an input device to be represented efficiently on a display device.

According to an exemplary embodiment, a graphical object, based on the movement of an input device, is automatically displaced toward the center of a display device in response to the movement of the input device. This displacement gives the observer the impression that the graphical object is being held in the center of the display device during the movement of the input device.

Under the embodiment, a graphical object which, irrespective of knowledge about reference point and scaling of the representation of the graphical object, is input by the movement of an input device and is automatically represented in the center of a display device. By means of a continuous displacement of the representation of the graphical object during the movement of the input device, and consequently during the input of the graphical object, it can also be achieved that the use of the display device is optimized even while the graphical object is being input.

In this context a graphical object is understood to mean, for example, a character, a numeral, a letter, a graphical sub-object such as a circle, a rectangle or an arrow, and/or a plurality of graphical sub-objects. The end of the input of a graphical object can be detected automatically here for example by means of algorithms known per se as part of a character recognition system or signaled by means of a corresponding user input.

An input pen embodied independently of the display device is preferably used as the input device, wherein the input pen includes a sensor device in the pen tip in order to register a movement of the input pen relative to a surface formed independently of the display device, such as a table surface, a briefcase surface or a textile surface.

The display device can be formed by means of a graphics display or a section of a graphics display such as, for example, a graphics window.

A preferred embodiment of the invention provides that the representation of the graphical object is held in the center of the display device as a result of the graphical object being inscribed into a geometric shape, the center of the geometric shape being determined, and the graphical object automatically being represented in such a way that the center of the geometric shape is identical with the center of the display device. Needless to say, the invention also includes cases in which a different fixed relationship exists between the center of the geometric shape and the center of the display device, in particular in which the center of the geometric shape is essentially identical with the center of the display device.

The inscribing of the graphical object into a geometric shape comprises in particular the enveloping of the graphical object by a geometric shape, with the dimensions of the geometric shape being as small as possible, but just large enough to completely enclose the graphical object.

In this case the same shape by which the display device is delimited is preferably used as the geometric shape. In most cases this will be a rectangle. In this way the limited area of the display device can be used efficiently and uniformly for the user.

In order to improve the use of the limited area of the display device further it can be provided that the representation of the graphical object is automatically reduced in size in response to the movement of the input device if the dimensions of the geometric shape exceed the dimensions of the display device. Also included are cases in which a fixed value is deducted from the dimensions of the display device or a fixed value is added to the dimensions of the geometric shape before the comparison is made.

The dimension of the geometric shape (e.g., rectangle) will generally relate to the height and/or the width of the shape.

Pursuant to the present disclosure, a communication device is also disclosed which is developed in accordance to the systems and methods described herein.

### DETAILED DESCRIPTION OF THE DRAWINGS

The various objects, advantages and novel features of the present disclosure will be more readily apprehended from the following Detailed Description when read in conjunction with the enclosed drawings, in which:

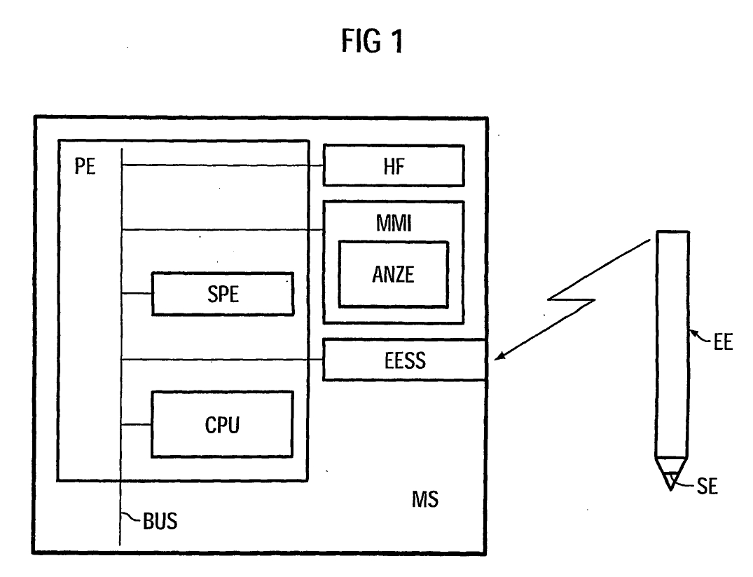

FIG. 1 is a block diagram of a mobile telephone equipped with an input pen;

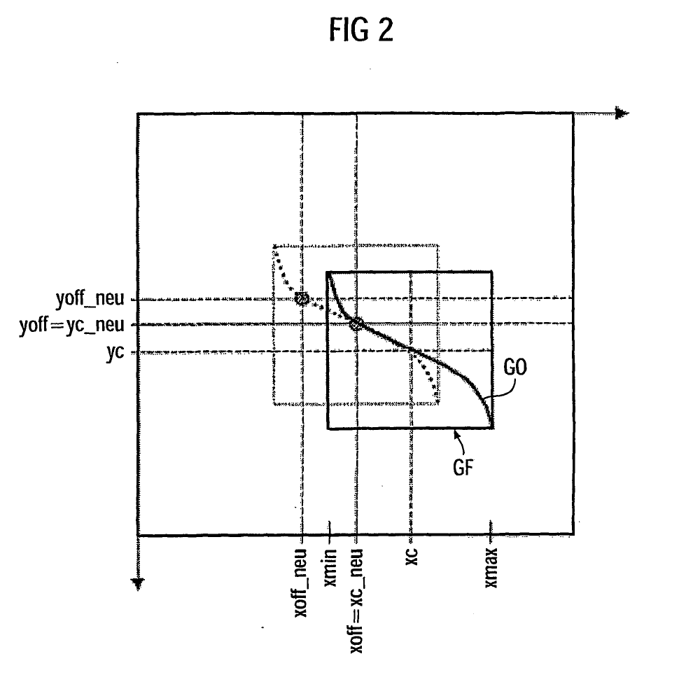

FIG. 2 is a diagram of a displacement of the representation of a graphical object;

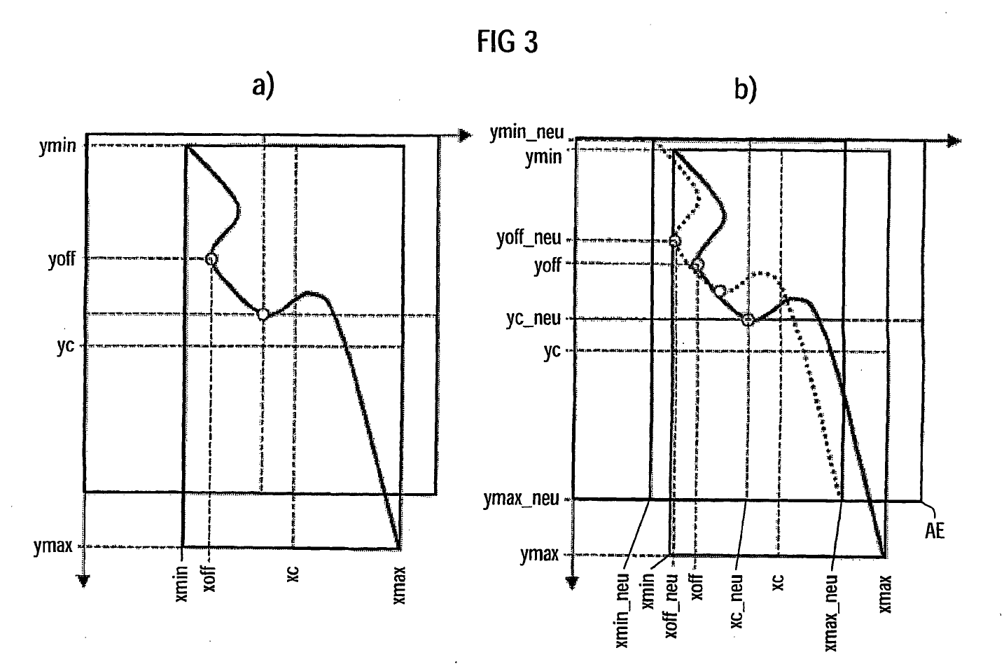

FIG. 3 is a first diagram of a displacement and reduction in size of the representation of a graphical object;

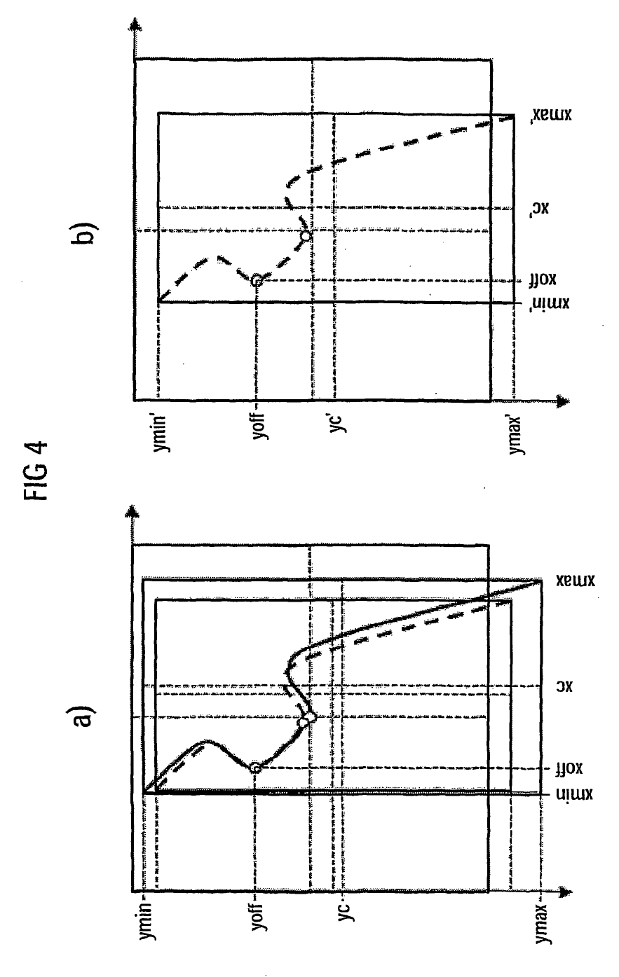

FIG. 4 is a second diagram of a displacement and reduction in size of the representation of a graphical object;

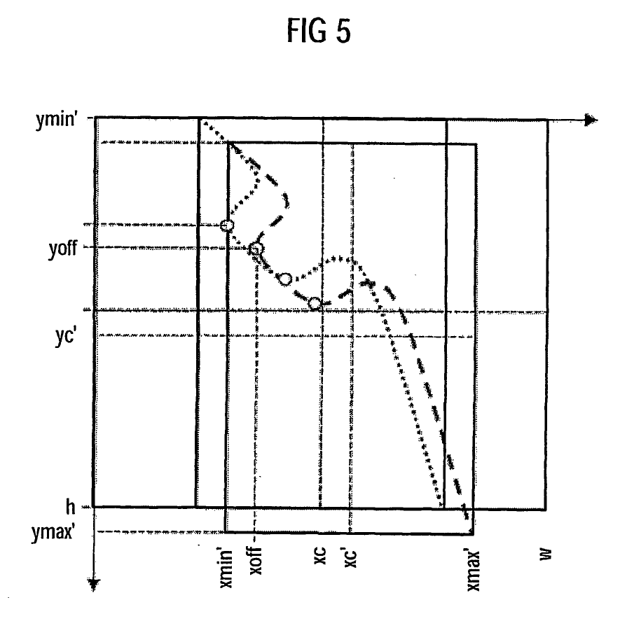

FIG. 5 is a third diagram of a displacement and reduction in size of the representation of a graphical object; and

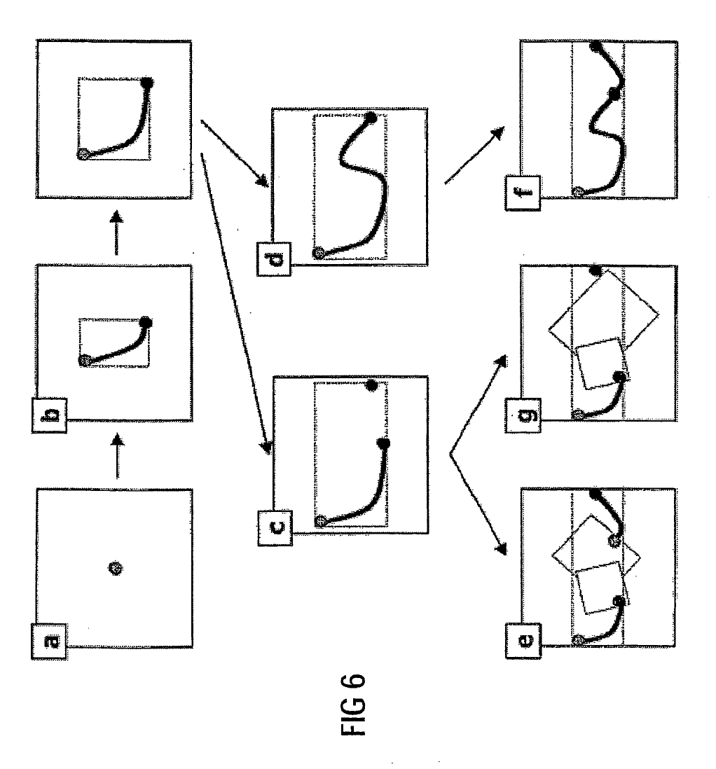

FIG. 6 is a flow diagram of the representation of a graphical object.

### DETAILED DESCRIPTION

FIG. 1 shows a mobile telephone MS which contains a control device MMI, a radio frequency device HF and a processor device PE. The control device MMI comprises a display device ANZE such as a graphics display and actuating elements such as keys or softkeys.

A program-controlled processor device PE such as a microcontroller, which can also comprise a processor CPU and a memory device SPE, is provided for controlling the mobile telephone MS and the methods which are performed by the mobile telephone.

Depending on embodiment variant, further components—assigned to the processor device, belonging to the processor device, controlled by the processor device or controlling the processor device—such as, for example, a digital signal processor or other memory devices, can be disposed inside or outside the processor device PE; the operating principle of said components in connection with a processor device for controlling a mobile telephone is sufficiently known to a person skilled in the art and therefore will not be examined in greater detail at this juncture. The different components can exchange data with the processor CPU via a bus system BUS or input/output interfaces and where appropriate suitable controllers.

The program data, such as the control commands or control procedures which are used for controlling the mobile telephone, are stored in the memory device SPE.

The mobile telephone MS is connected either cordlessly or by corded means via an input device interface EESS to an input device, in particular an input pen EE, which contains a sensor device SE for registering the movement of the input device relative to a surface.

FIG. 2 shows the displacement or, as the case may be, the retention of a graphical object GO in the center of a display device.

The following steps are performed continuously or at fixed or variable time intervals during the input of a graphical object. The smaller the time intervals, the more the displacement of the graphical object is perceived by the observer as though the graphical object were being held in the center of the display device.

The start of the input of a graphical object can be determined for example by the sensor device being brought into contact with a surface. With the start of the input, the start point xoff, yoff of the graphical object is represented in the center of the display device. In the following description, a graphical object in the process of being created is also understood to mean a graphical object, i.e. if the graphical object “F” is to be input, even just lines which form part of the graphical object “F” are also understood to be graphical objects.

First, the graphical object GO is inscribed into a simple geometric shape GF, i.e. a rectangle GF is placed around the graphical object, and the dimensions of the rectangle are adjusted to the dimensions of the graphical object so that the width and height of the rectangle essentially correspond to the width and height of the graphical object. In this case the width and height of the graphical object can be determined along the axes x and y of a coordinate system whose direction is predetermined by the edges of the display device. The sides of the rectangle can also run parallel to the edges of the display device.

The coordinates xc, yc of the center of the rectangle are now calculated:
xc=(xmax−xmin)/2+xmin=(xmax+xmin)/2
yc=(ymax−ymin)/2+ymin=(ymax+ymin)/2

The displacement vector dx, dy is then calculated:
dx=xc−xoff
dy=yc−yoff

Now all points of the graphical object are displaced by the displacement vector. For example, the start point originally represented in the center of the display device is represented at the following coordinates after displacement:
xoff_{—}neu=xoff−(xc−xoff)=2xoff−xc=width−xc
yoff_{—}neu=yoff−(yc−yoff)=2yoff−yc=height−yc

FIG. 3 now shows a rescaling of the graphical object performed simultaneously with the centering of the graphical object. This rescaling, in particular a reduction in scale, of the graphical object is initiated if the geometric element (bounding box) into which the graphical object is inscribed is larger than the display device at least along one axis (x or y).

In addition, the proportionality factors fx and fy are calculated based on width and height of the display device:
fx=width/(xmax−xmin)
fy=height/(ymax−ymin)

The smaller of the two values is then used as fneu for the rescaling:
fneu=min(fx,fy)

In this instance the rescaling can be confined to those cases in which fneu is less than 1 in order to allow only a reduction in scale of the graphical object. If a rescaling is also permitted when fneu is greater than 1, it is possible for graphical objects that are actually to be represented small also to be represented large according to the original setting.

Fist, the dimensions of the geometric element, in other words the rectangle, are now downscaled based on fneu, and the new limits xmax′ ymax′ xmin′ ymin′ of the rectangle are determined:
xmax′=xoff+(xmax−xoff)*fneu
xmin′=xoff+(xmin−xoff)*fneu
ymax′=yoff+(ymax−yoff)*fneu
ymin′=yoff+(ymin−yoff)*fneu

In addition, the new center xc′ yc′ is determined:
xc′=xoff+(xc−xoff)*fneu
yc′=yoff+(yc−yoff)*fneu

FIG. 5 shows that, as an alternative thereto, xc′ yc′ can also be determined by means of the new limits alone:
xc′=(xmax′−xmin′)/2+xmin′=(xmax′+xmin′)/2
yc′=(ymax′−ymin′)/2+ymin′=(ymax′+ymin′)/2

The displacement vector is then determined by:
dx=xc′−xoff
dy=yc′−xoff.

FIG. 6 shows the representation of a graphical object beginning with the start of the input in FIG. 6a. In FIG. 6a, only the start point of the graphical object can be seen initially. A preset scaling factor is used to translate the movement of an input device into the representation of the graphical object.

The point of the graphical object which corresponds to the tip of the input pen is highlighted by being visualized as ink blots.

As the user moves the input device, the graphical object is represented on the display device (FIG. 6b, 6d, 6f) while at the same time being automatically centered (see above). If the graphical object consists of two graphical sub-objects (FIG. 6c, 6e, 6g), the two graphical sub-objects are inscribed into a common geometric shape and represented centered in relation to this common geometric shape.

It should be understood that the various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-9. (canceled)

10. A method for representing a graphical object, translating a movement of an input device into a graphical object;
representing the graphical object on a display device; and
automatically displacing the representation of the graphical object toward the center of the display device in response to the movement of the input device.

11. The method as claimed in claim 10, wherein the graphical object is inscribed into a geometric shape.

12. The method as claimed in claim 10, further comprising:
determining the center of the geometric shape, wherein the graphical object is automatically represented in such a way that the center of the geometric shape is identical with the center of the display device.

13. The method as claimed in claim 10, wherein the representation of the graphical object is automatically reduced in size in response to the movement of the input device if the dimension of the geometric shape exceeds the dimension of the display device.

14. The method as claimed in claim 10, wherein the input device comprises a sensor device for registering a movement of the input device over a reference surface.

15. The method as claimed in claim 10, wherein the input device is embodied as an input pen.

16. The method as claimed in claim 15, wherein the sensor device is disposed in the pen tip.

17. The method as claimed in claim 16, wherein while the input device is being moved, the representation of the graphical object which is based on the movement of the input device is highlighted at the point of the graphical object that corresponds to the tip of the input pen.

18. A communication device, comprising:
an input device interface for connecting the communication terminal to an input device;
a display; and
a processor device coupled to the input device interface and the display, wherein the processor device is arranged such that a movement of the input device is translated into a graphic object;
the graphical object is represented on the display device, and
the representation of the graphical object is automatically displaced toward the center of the display device in response to the movement of the input device.
